(19) United States
(12) Patent Application Publication
(10) Pub. No.: US 2025/0042444 A1
(43) Pub. Date: Feb. 6, 2025

(54) PERSONALIZED TAKEOVER PREDICTION WITH DRIVER TACTILE INPUTS

(71) Applicant: TOYOTA MOTOR ENGINEERING & MANUFACTURING NORTH AMERICA, INC., Plano, TX (US)

(72) Inventors: Ziran Wang, San Jose, CA (US); Rohit Gupta, Santa Clara, CA (US); Kyungtae Han, Palo Alto, CA (US); Runjia Du, West Lafayette, IN (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-Shi (JP)

(21) Appl. No.: 18/363,671

(22) Filed: Aug. 1, 2023

(51) Int. Cl. B60W 60/00; B60W 40/09; B60W 50/14

(52) U.S. Cl. CPC B60W 60/0053; B60W 40/09; B60W 50/14; B60W 2540/043; B60W 2540/223; B60W 2540/229

(57) ABSTRACT

Systems and methods of transitioning a vehicle from being autonomously controlled by an autonomous vehicle control system to being controlled by a driver upon the driver taking over driving of the vehicle are disclosed. Exemplary implementations may: obtain tactile information corresponding to the driver of the vehicle while the vehicle is being autonomously controlled by the autonomous vehicle control system; predict, using the tactile information, when the driver will be ready to take over driving of the vehicle from the autonomous vehicle control system; alert the driver to take over driving of the vehicle from the autonomous vehicle control system based on the prediction as to when the driver will be ready to take over driving of the vehicle; and transition the vehicle from being autonomously controlled by the autonomous vehicle control system to being controlled by the driver upon the driver taking over driving of the vehicle.

### TECHNICAL FIELD

The present disclosure relates generally to controlling operation of an autonomous vehicle, and in particular, some implementations may relate to driver takeover prediction with tactile inputs when transitioning a vehicle from being autonomously controlled by an autonomous vehicle control system to being controlled by a driver.

### DESCRIPTION OF RELATED ART

Autonomous vehicles, with various levels of automation, have been increasingly playing a significant role in the development of vehicle intelligence technologies. Vehicles equipped with Level 3 vehicle automation present an exciting new development in vehicle technology. Level 3, as set forth by the Society of Automotive Engineers (SAE), is a highly automated driving level that allows for conditional driving automation, in which vehicles have environmental detection capabilities and can make informed decisions for themselves, such as accelerating past a slow-moving vehicle. Under Level 3, these vehicles enable drivers to take their hands off the steering wheel while the automated feature is in place. This allows the driver to freely engage in non-driving tasks.

### BRIEF SUMMARY OF THE DISCLOSURE

According to various embodiments of the disclosed technology, a method comprises: obtaining tactile information corresponding to a driver of a vehicle while the vehicle is being autonomously controlled by an autonomous vehicle control system; predicting, using the tactile information, when the driver will be ready to take over driving of the vehicle from the autonomous vehicle control system; alerting the driver to take over driving of the vehicle from the autonomous vehicle control system based on the prediction as to when the driver will be ready to take over driving of the vehicle; and transitioning the vehicle from being autonomously controlled by the autonomous vehicle control system to being controlled by the driver upon the driver taking over driving of the vehicle.

In some embodiments, the method further comprises using the tactile information to classify the driver into a driver type, wherein the predicting step is based on the driver type. The driver type may comprise a driving behavior of the driver. The driving behavior of the driver may identify the driver as a distracted driver or an engaged driver. The method may further comprise adjusting, time-wise, the step of alerting based on whether the driver is identified as a distracted driver or an engaged driver.

In some embodiments, the method further comprises identifying the driver based on the driver type.

In some embodiments, the method further comprises using the tactile information to classify the driver into one driver type selected from a plurality of driver types which are stored remotely and which correspond to multiple drivers, wherein the predicting step is based on the one driver type.

In some embodiments, the tactile information is obtained using at least one tactile interface selected from the group consisting of a steering wheel, seat, seat belt, pedal, dashboard, and clothing.

In some embodiments, the tactile information is obtained using a steering wheel tactile interface, wherein the tactile information is based on hand orientation of the driver on the steering wheel.

In some embodiments, the tactile information is obtained using a seat tactile interface, wherein the tactile information is based on seating position of the driver on the seat.

According to additional embodiments of the disclosed technology, a vehicle comprises: a processor; and a memory coupled to the processor to store instructions. When the instructions are executed by the processor, the processor is caused to perform operations. The operations comprise: obtaining tactile information corresponding to a driver of the vehicle while the vehicle is being autonomously controlled by an autonomous vehicle control system; predicting, using the tactile information, when the driver will be ready to take over driving of the vehicle from the autonomous vehicle control system; alerting the driver to take over driving of the vehicle from the autonomous vehicle control system based on the prediction as to when the driver will be ready to take over driving of the vehicle; and transitioning the vehicle from being autonomously controlled by the autonomous vehicle control system to being controlled by the driver upon the driver taking over driving of the vehicle.

In some embodiments, the operations further comprise using the tactile information to classify the driver into a driver type, wherein the predicting step is based on the driver type. The driver type may comprise a driving behavior of the driver. The driving behavior of the driver may identify the driver as a distracted driver or an engaged driver. The operations may further comprise adjusting, time-wise, the step of alerting based on whether the driver is identified as a distracted driver or an engaged driver.

In some embodiments, the operations further comprise identifying the driver based on the driver type.

In some embodiments, the operations further comprise using the tactile information to classify the driver into one driver type selected from a plurality of driver types which are stored remotely and which correspond to multiple drivers, wherein the predicting step is based on the one driver type.

In some embodiments, the tactile information is obtained using at least one tactile interface selected from the group consisting of a steering wheel, seat, seat belt, pedal, dashboard, and clothing.

In some embodiments, the tactile information is obtained using a steering wheel tactile interface, wherein the tactile information is based on hand orientation of the driver on the steering wheel.

In some embodiments, the tactile information is obtained using a seat tactile interface, wherein the tactile information is based on seating position of the driver on the seat.

According to further embodiments of the disclosed technology, a non-transitory machine-readable medium comprises instructions stored therein. When the instructions are executed by a processor, the processor is caused to perform operations. The operations comprise: obtaining tactile information corresponding to a driver of a vehicle while the vehicle is being autonomously controlled by an autonomous vehicle control system; predicting, using the tactile information, when the driver will be ready to take over driving of the vehicle from the autonomous vehicle control system; alerting the driver to take over driving of the vehicle from the autonomous vehicle control system based on the prediction as to when the driver will be ready to take over driving of the vehicle; and transitioning the vehicle from being autonomously controlled by the autonomous vehicle control system to being controlled by the driver upon the driver taking over driving of the vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example architecture for a vehicle control system for transitioning a vehicle from being autonomously controlled by an autonomous vehicle control system to being controlled by a driver with which embodiments of the disclosed technology may be implemented.

FIG. 2 illustrates examples of different tactile inputs from a driver within a cabin of a vehicle, in accordance with embodiments disclosed herein.

FIG. 3 illustrates an example steering wheel with six tactile inputs available for detecting different positions of one or both hands of a driver of a vehicle, in accordance with embodiments disclosed herein.

FIG. 4 illustrates an example implementation of a system framework of a personalized takeover prediction using driver tactile inputs, in accordance with embodiments disclosed herein.

FIG. 5 is a flowchart illustrating example operations for driver takeover prediction using tactile information when transitioning a vehicle from being autonomously controlled by the autonomous vehicle control system to being controlled by a driver, in accordance with embodiments disclosed herein.

FIG. 6 is an example computing component that may be used to implement various features of embodiments described in the present disclosure.

The figures are not exhaustive and do not limit the present disclosure to the precise form disclosed.

### DETAILED DESCRIPTION

As alluded to above, in accordance with a Level 3 autonomous control of a vehicle, drivers may relinquish operative control of the vehicle (e.g., letting go of the steering wheel). While this allows the driver to freely engage in non-driving tasks, the driver may be required to disengage from their non-driving tasks to regain manual control whenever requested by an autonomous vehicle (AV) control system. In other words, drivers are still required to stay alert and take over when the AV control system is unable to execute certain commands while the vehicle is being autonomously controlled by the AV control system. This poses a challenge, namely how to enable the driver to switch back from non-driving tasks to manually/actively driving, ensuring a safe and smooth takeover transition. Better methods are needed to improve automated vehicle operation in terms of strategies to safely and smoothly handover the control from the automated vehicle to the driver.

Embodiments of the systems and methods disclosed herein can provide transitioning of an autonomous vehicle from being autonomously controlled by the AV control system to being controlled by the driver. In some examples, the systems and methods described in this disclosure can provide an alert to the driver of the vehicle to take over driving of the vehicle being autonomously controlled by an AV control system, based on a prediction technique, using tactile information, as to when the driver will be ready to take over driving of the vehicle. In other words, examples of the disclosed technology use driver's tactile input information (i.e., tactile input(s)) to predict and provide an alert (or message) to the driver as to when the driver will be ready to take over when the automated vehicle cannot handle certain edge cases, e.g., in those cases when a problem or situation occurs at an extreme operating parameter during autonomous control that, if not remedied (i.e., removed from autonomous control), would likely result in an accident or incorrect trajectory for the vehicle. For example, if there is a sudden construction zone or obstacle in the lane within the current vehicle's trajectory and the vehicle likely cannot handle because the zone or obstacle is not in the current map, then the vehicle will send a warning alert to the driver to request the driver to take over the vehicle controls.

Automated vehicles have been gaining increasing attention from both academia and industry. Level 3 vehicle automation, or highly automated driving, presents an exciting new development in vehicle technology. This level of automation allows the driver to freely engage in non-driving tasks, but the driver is required to disengage from their non-driving tasks to regain manual control whenever requested by the system. This poses a new challenge, namely how to enable the human to switch back from non-driving tasks to driving, ensuring a safe and smooth takeover transition of control from the automated vehicle to the driver.

This challenge requires a driver-automation collaboration that considers the driver's takeover capability in real time. Driver's takeover readiness/capability can be assessed through factors such as his or her cognitive attention and workload, and vision based driver monitoring methodologies, such as using an in-cabin camera to record the driver's head angle, gaze position, blinking frequency, arousal-valence emotion, etc. The existing conception of driver workload has mostly been based on driving-related tasks, while the limited work on vision-based driver monitoring methodologies has mostly focused on conventional manual driving. Due to the large differences in these tasks, these bodies of research cannot accurately inform our understanding of driver states during the handover process in a highly automated driving scenario.

Moreover, vision-based driver monitoring methodologies do not take advantage of data directly produced from the human-autonomy interaction (i.e., through the use of tactile inputs from the driver). Instead, vision-based driver monitoring methodologies are passive monitoring techniques that utilize, for example, vision inputs. In such a passive monitoring system, the attention paid by the driver on the vehicle status can still be intuitively measured, but to a lesser degree as compared to a human autonomy interaction when using tactile inputs. And, in tactile-input based systems, the takeover time and takeover quality of potential takeover actions from the driver can be more accurately modeled. An example of the takeover quality can be a measurement of whether the driver needs additional time because he/she is still groggy and slow to react, and therefore not as responsive, as a result of abruptly being woken up by the takeover system alert.

As a further benefit, driver's data privacy can be better preserved by tactile inputs rather than by vision inputs. Tactile sensors (also referenced in this disclosure as tactile interfaces) only record anonymous data that does not necessarily reveal the driver's identity, while in-cabin cameras record the facial characteristics of the driver, which often gives away the driver's identity. Data privacy is one of the major reasons why mainstream automotive OEMs have not implemented in-cabin cameras on their mass-produced vehicles.

Further, Level 3 automation is a conditional driving automation, where Level 3 vehicles have “environmental detection” capabilities and can make informed decisions for themselves, such as accelerating past a slow-moving vehicle. These vehicles enable drivers to, for example, take their hands off the wheel, interface with the dashboard, interact with other passengers, and adopt a more-relaxed seating and foot position, while the automated feature is in place. However, drivers are still required to stay alert and take over in a timely manner when the automated system is unable to execute commands, including complex commands which come into play, for example, when the vehicle is accelerating past a slow-moving vehicle, or when the vehicle must avoid an obstacle (such as another vehicle, traffic sign, pedestrian, animal, light pole, and pothole) that suddenly appears in the vehicle's trajectory.

In order to deal with the above driver-automation problems in automated vehicles, embodiments of the present disclosure describe a novel control tactile takeover system, along with a detailed methodology. More specifically, tactile inputs from the driver of a Level-3 vehicle are used to provide a learning-based personalized predictive framework enabling predictions of the driver's takeover time and takeover quality.

Compared to current technologies, such as the ones discussed above, embodiments of the systems and methods disclosed herein have many improvements associated therewith. For example, because the tactile inputs are obtained directly from the driver, they can be easily deployed on existing mass-produced vehicles without compromising the data privacy of the driver. Meaning data is not stored in the cloud or elsewhere, thereby safeguard access to the data. In another example improvement, a personalized machine learning framework is developed which enables the prediction results of different drivers' takeover actions to be more accurate than a generic approach relating to takeover actions of a single driver. With this refined approach that relies on, for example, personalized or categorical driver types, predictions of the driver's takeover time and quality are greatly improved. In a further example improvement, the machine learning framework can be split into online and offline phases, which offloads time-consuming computing tasks to offline, hence enabling the prediction results to be generated in real-time by inference to pre-trained Transformer models. As is currently known, Transformers are a type of neural network that solves a problem of sequence transduction, or neural machine translation. That means a transformer includes any task that transforms an input sequence to an output sequence.

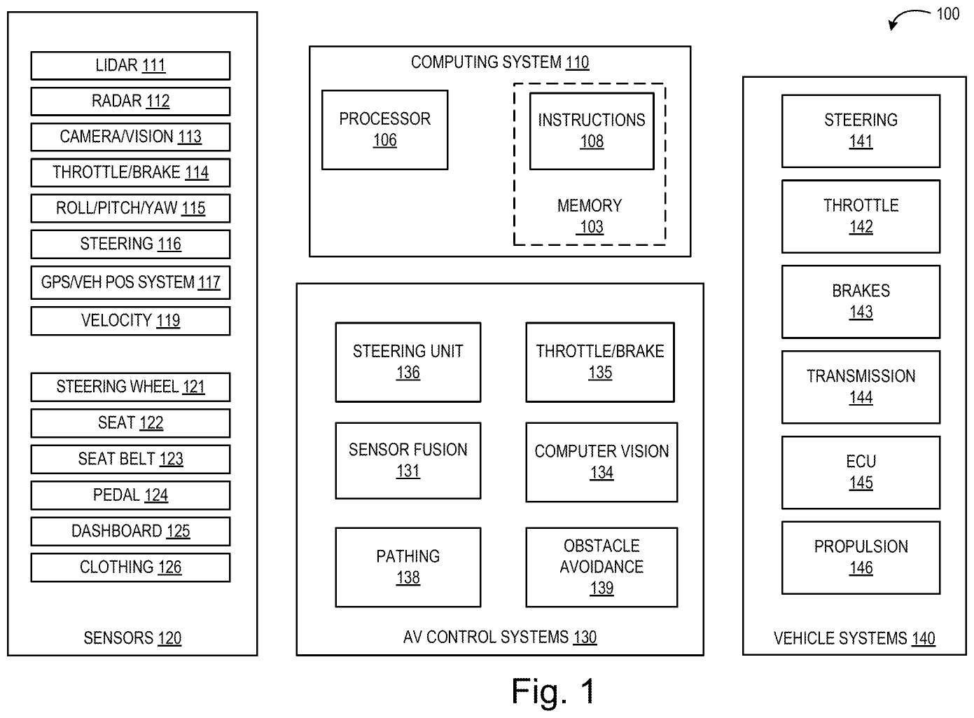

The systems and methods disclosed herein may be implemented with any of a number of different autonomous vehicles and vehicle types. For example, the systems and methods disclosed herein may be used with cars, trucks, buses, construction vehicles and other on- and off-road vehicles. These can include vehicles for transportation of people/personnel, materials or other items. In addition, the technology disclosed herein may also extend to other vehicle types as well. An example Autonomous Vehicle (AV) in which embodiments of the disclosed technology may be implemented is illustrated in FIG. 1.

FIG. 1 illustrates an example autonomous vehicle with which embodiments of the disclosed technology may be implemented. In this example, vehicle 100 includes a computing system 110, sensors 120, AV control systems 130 and vehicle systems 140. Vehicle 100 may include a greater or fewer quantity of systems and subsystems and each could include multiple elements. Accordingly, one or more of the functions of the technology disclosed herein may be divided into additional functional or physical components, or combined into fewer functional or physical components. Additionally, although the systems and subsystems illustrated in FIG. 1 are shown as being partitioned in a particular way, the functions of vehicle 100 can be partitioned in other ways. For example, various vehicle systems and subsystems can be combined in different ways to share functionality.

Sensors 120 may include a plurality of different sensors to gather data regarding vehicle 100, its operator, its operation and its surrounding environment. In this example, sensors 120 include LIDAR 111, radar 112, or other distance measurement sensors, image (camera/vision) sensors 113, throttle and brake sensors 114, 3D accelerometers 115 (e.g., to detect roll/pitch/yaw or, alternatively, to detect just one vehicle orientation such as yaw), steering sensors 116, GPS or other vehicle positioning system 117, and a velocity sensor 119. This example also includes additional sensors 120 such as steering wheel sensors 121, seat sensors 122, seat belt sensors 123, pedal sensors 124, dashboard sensors 125, and/or clothing sensors 126. Additional sensors can also be included as may be appropriate for a given implementation of AV control systems 130. For example, sensors 120 can include environmental sensors (e.g., to detect road/ground conditions such as ground wetness, ice, or other environmental conditions including, for example, atmospheric conditions such as weather). One or more of the sensors 120 may gather data and send that data to the vehicle electronic control unit (ECU) 145 or other processing unit. Sensors 120 (and other vehicle components) may be duplicated for redundancy.

Distance measuring sensors such as LIDAR 111, radar 112, IR sensors and other like sensors can be used to gather data to measure distances and closing rates to various external environmental conditions (such as ice patches) or objects such as other vehicles, obstacles (such as an other vehicle, traffic sign, pedestrian, animal, light pole, and pothole), and other objects. Image sensors 113 can include one or more cameras or other image/vision sensors to capture images of the environment around the vehicle. Information from image sensors 113 can be used to determine information about the environment surrounding the vehicle 100 including, for example, information regarding other objects surrounding vehicle 100. For example, image sensors 113 may be able to recognize landmarks or other features (including, e.g., street signs, traffic lights, etc.), slope of the road, lines on the road, curbs, objects/obstacles/environmental changes to be avoided (e.g., other vehicles, pedestrians, bicyclists, etc.) and other landmarks or features. Information from image sensors 113 can be used in conjunction with other information such as map data or information from positioning system 117 to determine, refine or verify vehicle location. Moreover, information from image sensors 113 can alternatively or additionally be used in conjunction with other information such as from the LIDAR 111 or radar sensors 112 to determine, refine or verify distances of any of the above items (e.g., obstacles/environmental changes) relative to the vehicle.

Throttle and brake sensors 114 can be used to gather data regarding throttle and brake application generated autonomously. Accelerometers 115 may include a 3D accelerometer to measure roll, pitch and yaw of the vehicle (or to measure just one vehicle orientation such as yaw, if desired). Accelerometers 115 may include any combination of accelerometers and gyroscopes for the vehicle or any of a number of systems or subsystems within the vehicle to sense position and orientation changes based on inertia.

Steering sensors 116 (e.g., such as a steering angle sensor) can be included to gather data regarding steering input for the vehicle generated autonomously (i.e., via the steering unit 136 (described below) while the vehicle is being autonomously controlled by the AV control system 130). A steering sensor may include a position encoder to monitor the angle of the steering input in degrees. Analog sensors may be used to collect voltage differences that can be used to determine information about the angle and turn direction, while digital sensors may use an LED or other light source to detect the angle of the steering input. A steering sensor may also provide information on how rapidly the steering wheel is being turned. A steering wheel being turned quickly is generally normal during low-vehicle-speed operation, but is generally unusual at highway or other high speeds. Excessive steering input (e.g., turning a steering wheel quickly while the vehicle is traveling at such high speeds) can lead to vehicle control issues due to, for example, tire slippage from insufficiently low tire friction between the tire and road, in relation to the vehicle speed. In other words, if the steering unit 136 is turning the steering wheel at a fast rate while driving at highway or other high speeds, the vehicle computing system 110 may interpret that as an indication that the vehicle is out-of-control. Steering sensor 116 may also include a steering torque sensor to detect an amount of force the steering unit 136 is applying to the steering wheel.

Vehicle positioning system 117 (e.g., GPS or other positioning system) can be used to gather position information about a current location of the vehicle as well as other positioning or navigation information.

vehicle velocity sensor 119 can be used to gather velocity information about a current speed of the vehicle. The vehicle velocity sensor 119 may also, for example, be embodied in GPS (or other positioning system) which can be used in calculating vehicle velocity by using multiple vehicle position information and timing information (i.e., the amount of time the vehicle takes to travel between vehicle positions). Alternatively, the vehicle velocity sensor 119 may be in the form of other non-wheel speed sensing techniques such as a transmission speed sensor which is a component mounted on a vehicle's transmission that lets the ECU 145 and/or computing system 110 know the current speed of the vehicle.

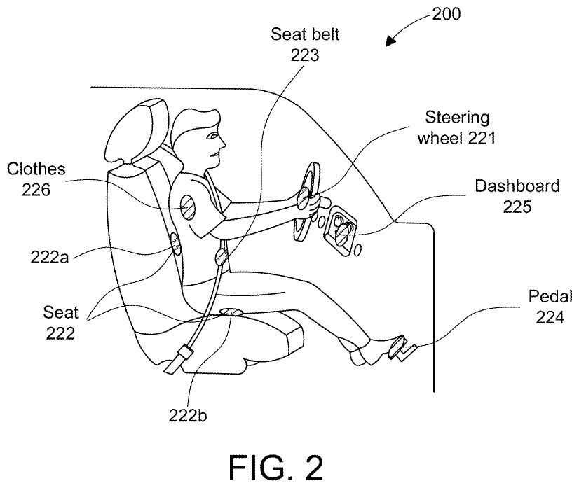

As commonly known, haptic technology (also referred to herein as haptics) use haptic interfaces (e.g., embedded in or provided at/on steering wheels and seats) to provide touch or force feedback as part of the user interface (UI) in vehicles. For example, a vibrating seat may be used to inform the driver of a pedestrian crossing the street. Haptic technology also has the potential to add new forms of driver/vehicle communication to a vehicle, for example, by using the same haptic interfaces to obtain tactile input information from the driver. This tactile input information may be used to predict and provide an alert to the driver as to when the driver will be ready to take over when the automated vehicle cannot handle certain edge cases. In other words, haptic interfaces (that provide touch or force feedback) may be used in addition to, or as an alternative to, non-haptic tactile interfaces, in order to obtain tactile input information from the driver. In this regard, the tactile (input) information, corresponding to a driver, described in any of the examples in this disclosure may be obtained via haptic interfaces (which may also be referred to as a haptic tactile interface) and/or non-haptic tactile interfaces, and these tactile interfaces may therefore be used interchangeably. An example of different tactile input interfaces to obtain tactile information corresponding to a driver within a cabin of a vehicle 200 that can be used in these new forms of driver/vehicle communication are illustrated in FIG. 2. The different tactile inputs are derived from various haptic and/or non-haptic tactile interfaces/sensors (e.g., provided within or on steering wheels 221, seats 222, seat belts 223, pedals 224, dashboards 225, and clothing 226) to provide tactile information that will be used in the prediction to provide the alert to the driver as to when the driver will be ready to take over driving of the vehicle from an AV control system.

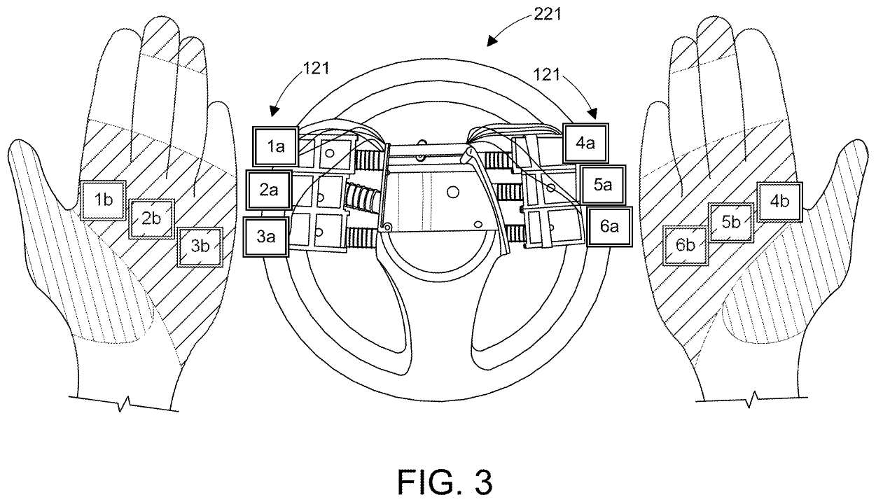

The above tactile inputs from the driver can be easily obtained/measured by existing tactile sensing technologies currently provided on mass-produced vehicles. As an example, as shown in FIG. 3, tactile feedback within a steering wheel can also sense the force/pressure from the driver's hands and can provide a tactile alert to the driver. This feature can be used as an alternative to visual and auditory alerts or in conjunction with them. Haptic feedback is often used as part of the lane departure warning (LDW)/lane keep assist (LKA) systems. In these LDW/LKA systems, the steering wheel will vibrate if, for example, the vehicle senses it is veering out of the lane. These systems typically include one or more haptic feedback motors and a control module which is in communication with the haptic feedback motors. The control module is used to, inter alia, activate the motors to cause the steering wheel to vibrate when, for example, the vehicle senses it is veering out of the lane.

With reference again to FIG. 1, the various sensors 121-126 sense/measure the driver's physical/tactile interaction with corresponding elements of the vehicle associated with the sensors. Steering wheel sensors 121 measure tactile inputs available for different positions of one or both hands of a driver. The steering wheel sensors 121 are housed and distributed within or on the example steering wheel 221 (FIG. 2) such that the driver's fingers and/or palm of one or both hands may be in contact with the steering wheel sensors 121 while the vehicle is being autonomously controlled by the AV control system 130. The dark oval portions in FIG. 2 represent points of contact that the driver makes with the various sensors 121-126 respectively associated with the example steering wheel 221, seat 222 (including top seat portion 222a and bottom seat portion 222b), seat belt 223, pedal 224, dashboard 225, and/or clothing 226. As mentioned above, in addition to obtaining tactile input information corresponding to the driver of the vehicle, any of the various sensors 121-126 (i.e., tactile interfaces) may optionally also provide touch or force feedback to the driver, and these types of tactile interfaces would therefore be considered haptic tactile interfaces.

In the example steering wheel 221 shown in FIG. 3, three steering wheel sensors 121 (labeled 1a, 2a, 3a) are provided for and respectively correspond to palm portions 1b, 2b, 3b of the driver's left hand. Similarly, another three steering wheel sensors 121 (labeled 4a, 5a, 6a) are provided for and respectively correspond to palm portions 4b, 5b, 6b of the driver's right hand. The tactile inputs from each of the steering wheel sensors 121 (i.e., 1a-6a) provide touch and/or force feedback indicating when palm portions 1b-6b and/or fingers (not labeled) are interacting with the steering wheel sensors 121 (i.e., 1a-6a). This feedback can be used to gather information about a current position (orientation) of and/or force applied by one or both of the driver's hands on the steering wheel 221. The steering wheel sensors 121 can be, for example, piezoresistive, piezoelectric, optical, capacitive, pressure, and/or elastoresistive sensors.

Seat sensors 122 measure tactile inputs available for different positions of the back and/or buttocks/thighs of a driver. The seat sensors 122 are housed and distributed within or on the example seat 222, i.e., within or on top seat portion 222a and bottom seat portion 222b (FIG. 2), such that the driver's back and/or buttocks/thighs may be in contact with the seat sensors 122 (i.e., provided at the top seat portion 222a and bottom seat portion 222b, respectively) while the vehicle is being autonomously controlled by the AV control system 130. In the example seat 222 (i.e., top seat portion 222a and bottom seat portion 222b) shown in FIG. 2, seat sensors 122 (not shown) are provided for and respectively correspond to the back and buttocks/thighs of the driver. The tactile inputs from each of the seat sensors 122 provide touch and/or force feedback indicating when the driver's back and/or buttocks/thighs are interacting with the seat sensors 122. This feedback can be used to gather information about a current position of (and/or force applied by) the driver's back and/or buttocks/thighs (i.e., corresponding to a seating position of the driver) on the seat 222. The seat sensors 122 can be, for example, piezoresistive, piezoelectric, optical, capacitive, pressure/weight, and/or elastoresistive sensors.

Seat belt sensors 123 measure tactile inputs available for different positions of the torso (e.g., shoulder, chest, abdomen, and/or pelvis) of a driver. The seat belt sensors 123 are housed and distributed within or on the example seat belt 223 (FIG. 2) such that the driver's torso may be in contact with the seat belt sensors 123 while the vehicle is being autonomously controlled by the AV control system 130. In the example seat belt 223 shown in FIG. 2, seat belt sensors 123 (not shown) are provided for and correspond to the torso of the driver. The tactile inputs from the seat belt sensors 123 provide touch and/or force feedback indicating when the driver's torso is interacting with the seat belt sensors 123. This feedback can be used to gather information about a current position of and/or force applied by the driver's torso on the seat belt 223. The seat belt sensors 123 can be, for example, piezoresistive, piezoelectric, optical, capacitive, pressure/tension, and/or elastoresistive sensors.

Pedal sensors 124 measure tactile inputs available for different positions of the foot of a driver. The pedal sensors 124 are housed and distributed within or on the example pedal 224 (FIG. 2) such that the driver's foot may be in contact with the pedal sensors 124 while the vehicle is being autonomously controlled by the AV control system 130. In the example pedal 224 shown in FIG. 2, pedal sensors 124 (not shown) are provided for and correspond to the foot of the driver. The tactile inputs from the pedal sensors 124 provide touch and/or force feedback indicating when the driver's foot is interacting with the pedal sensors 124. This feedback can be used to gather information about a current position of and/or force applied by the driver's foot on the pedal 224. The pedal sensors 124 can be, for example, piezoresistive, piezoelectric, optical, capacitive, pressure/force, and/or elastoresistive sensors.

Dashboard sensors 125 measure tactile inputs available for different positions of (or swiping by) the fingers of a driver. The dashboard sensors 125 are housed and distributed within or on the example dashboard 225 (FIG. 2) such that the driver's fingers may be in contact with the dashboard sensors 125 while the vehicle is being autonomously controlled by the AV control system 130. In the example dashboard 225 shown in FIG. 2, dashboard sensors 125 (not shown) are provided for and correspond to the fingers of the driver. The tactile inputs from the dashboard sensors 125 provide touch and/or force feedback indicating when the driver's fingers are interacting with the dashboard sensors 125. This feedback can be used to gather information about a current position of and/or force applied by the driver's fingers on the dashboard 225. The dashboard sensors 125 can be, for example, piezoresistive, piezoelectric, optical, capacitive and/or elastoresistive sensors.

Clothing sensors 126 measure tactile inputs available for different positions of the body (e.g., torso, legs, head, hands, neck, buttocks, etc.) of a driver. The clothing sensors 126 are housed and distributed within or on the example clothing 226 (FIG. 2) such that the driver's body may be in contact with the clothing sensors 126 while the vehicle is being autonomously controlled by the AV control system 130. The clothing may be any item wearable by the driver, such as a shirt, jacket, coat, vest, shorts, pants, underwear, hat, glove, scarf, etc. In the example clothing 226 shown in FIG. 2, clothing sensors 126 (not shown) are provided for and correspond to the body of the driver. The tactile inputs from the clothing sensors 126 provide touch and/or force feedback indicating when the driver's body is interacting with the clothing sensors 126. This feedback can be used to gather information about a current position of and/or force applied by the driver's body on the clothing 226. The clothing sensors 126 can be, for example, piezoresistive, piezoelectric, optical, capacitive, pressure/force, and/or elastoresistive sensors.

Although not illustrated, other sensors 120 may be provided as well. Various sensors 120 may be used to provide input to computing system 110 and other systems of vehicle 100 so that the systems have information useful to operate the vehicle while the vehicle is being autonomously controlled by the AV control system 130.

AV control systems 130 may include a plurality of different systems/subsystems to control operation of vehicle 100. In this example, AV control systems 130 include steering unit 136, throttle and brake control unit 135, sensor fusion module 131, computer vision module 134, pathing module 138, and obstacle avoidance module 139.

Sensor fusion module 131 can be included to evaluate data from a plurality of sensors, including sensors 120. Sensor fusion module 131 may use computing system 110 or its own computing system to execute algorithms to assess or otherwise use inputs from the various sensors.

Throttle and brake control unit 135 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (e.g., such as in a hybrid or electric vehicle) to slow or stop the vehicle.

Steering unit 136 may include any of a number of different mechanisms to control or alter the heading of the vehicle. For example, steering unit 136 may include the appropriate control mechanisms to adjust the orientation of the front and/or rear wheels of the vehicle to accomplish changes in direction of the vehicle during operation. Electronic, hydraulic, mechanical or other steering mechanisms may be controlled by steering unit 136.

Computer vision module 134 may be included to process image data (e.g., image data captured from image sensors 113, or other image data) to evaluate the environment surrounding the vehicle. For example, algorithms operating as part of computer vision module 134 can evaluate still or moving images to determine features and landmarks (e.g., road signs, traffic lights, lane markings and other road boundaries, etc.), obstacles (e.g., animals, pedestrians, bicyclists, other vehicles, other obstructions in the path of the subject vehicle) and other objects. The system can include video tracking and other algorithms to recognize objects such as the foregoing, estimate their speed and/or direction, map the surroundings, and so on.

Pathing module 138 may be included to compute a desired path for vehicle 100 based on input from various sensors 120 and AV control systems 130. For example, pathing module 138 can use information from positioning system 117, sensor fusion module 131, computer vision module 134, obstacle avoidance module 139 (described below) and other systems to determine a safe path to navigate the vehicle along a segment of a desired route. Pathing module 138 may also be configured to dynamically update the vehicle path as real-time information is received from sensors 120 and other AV control systems 130. This real-time information may be used as input for a computation of an optimal sequence/solution for the vehicle.

Obstacle avoidance module 139 can be included to determine control inputs necessary (i.e., input to vehicle systems 140) for controlling the vehicle's movement in order to avoid obstacles detected by sensors 120 or AV control systems 130. Obstacle avoidance module 139 can work in conjunction with pathing module 138 to determine an appropriate path to avoid a detected obstacle.

Vehicle systems 140 may include a plurality of different systems/subsystems to control operation of vehicle 100. In this example, vehicle systems 140 include steering system 141, throttle system 142, brakes 143, transmission 144, ECU 145 and propulsion system 146. These vehicle systems 140 may be controlled by AV control systems 130 while the vehicle is being autonomously controlled by the AV control system 130. For example, AV control systems 130, alone or in conjunction with other systems, can control vehicle systems 140 to operate the vehicle in a fully autonomous fashion.

Computing system 110 in the illustrated example includes a processor 106, and memory 103. Some or all of the functions of vehicle 100 may be controlled by computing system 110. Processor 106 can include one or more GPUs, CPUs, microprocessors or any other suitable processing system. Processor 106 may include one or more single core or multicore processors. Processor 106 executes instructions 108 stored in a non-transitory computer readable medium, such as memory 103.

Memory 103 may contain instructions (e.g., program logic) executable by processor 106 to execute various functions of vehicle 100, including those of vehicle systems and subsystems. Memory 103 may contain additional instructions as well, including instructions to transmit data to, receive data from, interact with, and/or control one or more of the sensors 120, AV control systems 130 and vehicle systems 140. In addition to the instructions, memory 103 may store data and other information used by the vehicle and its systems and subsystems for operation, including operation of vehicle 100 while the vehicle is being autonomously controlled by the AV control system 130.

Although one computing system 110 is illustrated in FIG. 1, in various embodiments multiple computing systems 110 can be included. Additionally, one or more systems and subsystems of vehicle 100 can include its own dedicated or shared computing system 110, or a variant thereof. Accordingly, although computing system 110 is illustrated as a discrete computing system, this is for ease of illustration only, and computing system 110 can be distributed among various vehicle systems or components. In some examples, computing functions for various embodiments disclosed herein may be performed entirely on computing system 110, distributed among two or more computing systems 110 of vehicle 100, performed on a cloud-based platform, performed on an edge-based platform, or performed on a combination of the foregoing.

Vehicle 100 may also include a wireless communication system (not illustrated) to communicate with other vehicles, infrastructure elements, cloud components and other external entities using any of a number of communication protocols including, for example, V2V, V2I and V2X protocols. Such a wireless communication system may allow vehicle 100 to receive information from other objects including, for example, map data, data regarding obstacles (such as obstacle 244 shown in FIGS. 2A-2C), data regarding infrastructure elements, data regarding operation and intention of surrounding vehicles, and so on.

The example of FIG. 1 is provided for illustration purposes only as one example of a vehicle system with which embodiments of the disclosed technology may be implemented. One of ordinary skill in the art reading this description will understand how the disclosed embodiments can be implemented with this and other vehicle platforms.

### An Example Implementation of a Transformer-Based System Framework 400 for Predicting Personalized Takeover Action of a Driver

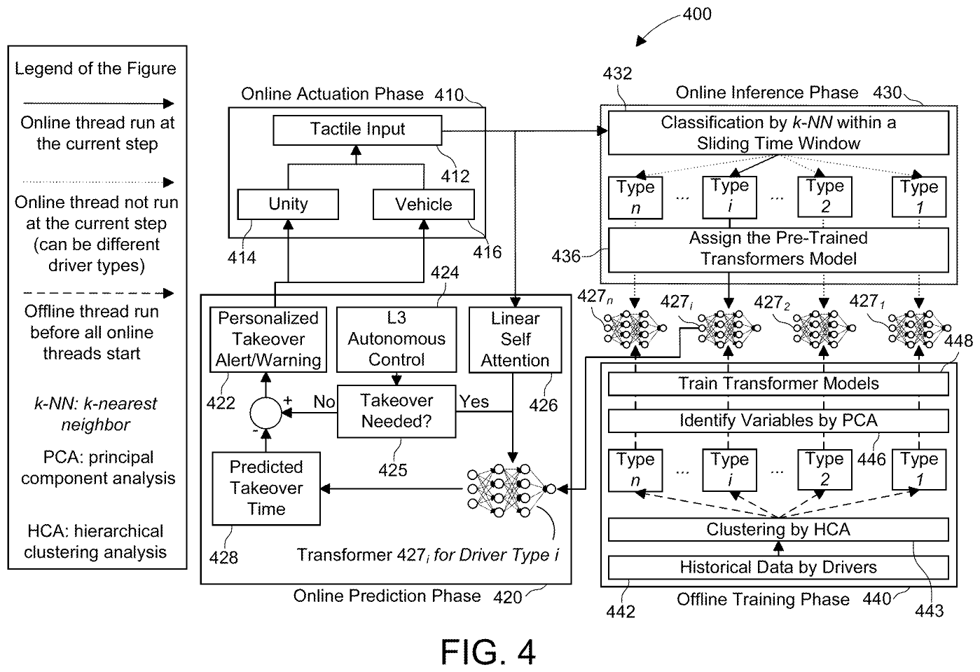

FIG. 4 illustrates an example implementation of a Transformer-based system framework 400 of a personalized takeover prediction using driver tactile inputs. In this implementation, the Transformer-based framework 400 is provided to predict the personalized takeover action of an individual driver. Drivers may be clustered into various categories based on their tactile inputs while the vehicle monitors these tactile inputs while in the Level 3 autonomous control 424. Based on these categories, Transformer models will be trained to make predictions of each category-type driver's takeover intention, takeover time and takeover quality in various traffic incidents/situations. In such a personalized human-autonomy takeover prediction system, the takeover prediction results will likely be improved over a takeover prediction system that does not use categorized driver types, since a comparison or reliance is made using information corresponding to similar behaviors/preferences derived from drivers of a same category type. However, it is noted that this clustering technique is an optional feature that is not necessarily required for takeover prediction.

In this example implementation of framework 400 which is described more fully here, a human-in-the-loop experiment is used to validate the effectiveness of the framework 400, where the driver is not always required in the decision-making process of the vehicle while in the Level 3 autonomous control 424, but should always be aware of its status and ready to engage/take over. The online actuation phase 410 of the implementation is conducted using a Unity 414 game engine-based vehicle and/or a Level 3 vehicle 416. This online actuation phase 410 uses the tactile input 412 (i.e., derived from either the Unity 414 game engine-based vehicle and/or the Level 3 vehicle 416) for inputs to the linear self-attention step 426 (where a driver's takeover time is calculated based on a time-series of his/her past tactile inputs, as explained more fully below) performed in the online prediction phase 420 and to the classification by k-NN within a sliding time window step 432 performed in the online inference phase 430. If a takeover is determined to be needed per step 425 then the linear self-attention 426 is used as input to Transformer 427ᵢ to predict the takeover time 428. The personalized takeover alert/warning 422 is then activated at the predicted takeover time 428.

In the online inference phase 430, the classification by k-NN within a sliding time window 432 identifies this driver online (again, using tactile input 412) as a particular type (e.g., Type_{n, i, 2, 1}) and classifies this driver's type based on a certain time period. The resultant classified driver type is assigned a particular Transformer 427ₙ, 427ᵢ, 427₂, 427₁ via the assigning pre-trained Transformers model 436. In framework 400, the Transformer 427ᵢ for Driver Type i is used to ultimately predict the takeover time 428 in the online prediction phase 420.

### Offline Training Phase 440

In the example offline training phase 440, historical tactile data 442 generated by the driver while the vehicle is being autonomously controlled by the AV control system is used to ultimately train Transformer models via step 448 in an offline manner. This is done by using the historical tactile data 442 to perform clustering by hierarchical clustering analysis (HCA) 443 (per Algorithm 1 below). The clustering by HCA 443 is used to classify the driver offline as a particular driver type (e.g., Type_{n, i, 2, 1}). Once the type of driver is classified, an identification of important variables is performed by principal component analysis (PCA) 446 (per Algorithm 2 below). This identification of important variables is used to train Transformer models via step 448 which is ultimately used in the offline training phase 440 to also train Transformers 427ₙ, 427ᵢ, 427₂, 427₁. Because the framework 400 is split into online and offline phases, time-consuming computing tasks are offloaded to offline which enables the prediction results to be generated in real-time by inference to pre-trained Transformer models.

Some example tactile data fields regarding the driver's hand pressure on the steering wheel can be obtained as follows: the variance of the hand pressure(σₕₚ); the mean error of hand pressure (μ_{Δ}_{ₕₚ}); the absolute mean error of hand pressure (|μ_{Δ}_{ₕₚ}|); and/or the variance of the hand pressure error (σ_{Δ}_{ₕₚ}). The pressure itself (i.e., applied by the driver's hand on the steering wheel) and/or any of these data fields based on that pressure may be used in the prediction takeover calculation. Alternatively, the pressure itself and/or any of these data fields based on that pressure may indicate a driver's hand position/orientation with respect to the steering wheel. In this alternative scenario, the driver's hand position/orientation may be used in the prediction takeover calculation.

Alternatively, example tactile data fields (i.e., generated by the driver while the vehicle is being autonomously controlled by the AV control system and used to train Transformer models in an offline manner) regarding the driver's back and/or buttocks/thighs pressure on the seat can be obtained as follows: the variance of the seat pressure(σₛₚ); the mean error of seat pressure (μ_{Δ}_{ₛₚ}); the absolute mean error of seat pressure (|μ_{Δ}_{ₛₚ}|); the variance of the seat pressure error (σ_{Δ}_{ₛₚ}); and/or the mean of seat pressure (μₛₚ). The pressure itself (i.e., applied by the driver's back and/or buttocks/thighs on the seat) and/or any of these data fields based on that pressure may be used in the prediction takeover calculation. Alternatively, the pressure itself and/or any of these data fields based on that pressure may indicate a driver's seating position with respect to the seat. In this alternative scenario, the driver's seating position may be used in the prediction takeover calculation.

In the two offline training examples above (i.e., using the steering wheel and seat), there are a combination of nine example tactile data fields (i.e., the variance of the hand pressure(σₕₚ); the mean error of hand pressure (μ_{Δ}_{ₕₚ}); the absolute mean error of hand pressure (|μ_{Δ}_{ₕₚ}|); the variance of the hand pressure error (σ_{Δ}_{ₕₚ}); the variance of the seat pressure (σₛₚ); the mean error of seat pressure (μ_{Δ}_{ₕₚ}); the absolute mean error of seat pressure (|μ_{Δ}_{ₛₚ}|); the variance of the seat pressure error (σ_{Δ}_{ₛₚ}); and the mean of seat pressure (μₛₚ)) which are representative of nine variables of driver behavior.

Since the number of driver types is not strictly defined in this implementation, an unsupervised learning approach may be used to cluster the driver into a particular category type. The pseudocode of this HCA is set forth as Algorithm 1 below. The Euclidean distance and Ward linkage method, which are both well-known HCA methods, are employed to create a hierarchical cluster tree for clustering. Each driver's data is combined as a matrix X, X={X₁, . . . , Xᵢ, . . . , Xₙ}, where Xᵢ={σₕₚ, μ_{Δ}_{ₕₚ}, |μ_{Δ}_{ₕₚ}|, σ_{δ}_{ₕₚ}, μ_{Δ}_{ₛₚ}, μₛₚ, |μ_{Δ}_{ₛₚ}|, σₛₚ, σ_{Δ}_{ₛₚ}}, and the Euclidean distance matrix D is computed as follows:

$$D = [ \begin{matrix}0 & {D}_{12} & … & {D}_{1 n - 1} & {D}_{1 n} \\ {D}_{21} & 0 & … & {D}_{2 n - 1} & {D}_{2 n} \\ ⋮ & ⋮ & ⋱ & ⋮ & ⋮ \\ {D}_{n - 11} & {D}_{n - 12} & … & 0 & {D}_{n - 1 n} \\ {D}_{n 1} & {D}_{n 2} & … & {D}_{nn - 1} & 0\end{matrix} ]$$

$$where {D}_{ij} = {‖ {X}_{i} - {X}_{j} ‖}_{2}^{2} .$$

Algorithm 1 HCA: Cluster the driving type

| | Input: Matrix (X) that contains nine variables of | |
|---|---|---|
| driver behavior and n data samples. | | |
| | Output: K clusters. | |
| 1: | Compute the distance matrix. | |
| 2: | While the number of clusters > 1 | |
| 3: | \| | Merge two clusters with the smallest Dᵢⱼ; |
| 4: | \| | Update the distance matrix; |
| 5: | \| | Save Dᵢⱼ and cluster ID in the stack; |
| 6: | | The number of clusters is cut in half; |

| | |
|---|---|
| 7: | end |
| 8: | Separate from one cluster into several clusters |

based on the median distance among recorded Dᵢⱼ.

As explained in Algorithm 1 above, when the dendrogram is generated based on the similarity of each data sample, the dendrogram is cut by the median Euclidean distances among the samples to obtain the final clusters. After filtering out the outlier samples, all valid samples in the driver dataset are clustered into four major types. Note that if more data samples are obtained, additional cluster types may be employed resulting in even better performance.

Once the clustering is completed, useful features from the data may be explored in order to obtain a more precise model. For instance, to predict the takeover time, the most contributing variables are identified as the objects for the neural network to predict. Moreover, in high dimensions, there is little difference between the nearest and the farthest neighbor for the k-nearest neighbors (k-NN) classification using Euclidean distance because of “the curse of dimensionality” (which indicates that the number of samples needed to estimate an arbitrary function with a given level of accuracy grows exponentially with respect to the number of input variables (i.e., dimensionality) of the function), so the input variables for classification may be reduced. As set forth in Algorithm 2 below, PCA is used to transform these nine correlated variables of driver's behavior into a set of linearly uncorrelated variables, which are called principal components. Note PCA is not utilized before the driver clustering since the computational burden is not bottlenecked by the clustering, and all the original variables are potentially helpful for the clustering.

As stated above in the n×9 matrix of the driver's tactile data, there are nine types/variables of driver behaviors and n data samples. Specifically, Algorithm 2 below is used to identify the important variables to predict the takeover time and takeover quality.

ALGORITHM 2
PCA: Identify the important variables

```
  Input: Matrix X that contains nine variables of driver behavior.
  Output: 1) Accumulate percentage of singular value (POS).
2) Correlation coefficients matrix;
1: Normalize the data matrix;
2: For each column Xⱼ in X, Xᵢ = Xᵢ − μ(Xᵢ);
3: Calculate the covariance matrix
  Kₓₓ = COV[X, X] = E[(X − μₓ)(X − μₓ)^{T}];
4: Calculate the singular values Σ and singular vector
  V, based on Kₓₓ = VΣ²V^{T};
$5: Arrange \sum in descending order POS = \frac{{\sum }_{i}}{sum ( \sum )} ;$
6: Calculate the correlation matrix (factor loading) R.
```

This section, including Equations (1)-(4), describes the use of machine learning algorithms to predict the behavior of a driver based on data, with each paragraph representing an intermediate process of the entire process. Once all historical data generated by various drivers are clustered, the Transformer model is trained to predict the takeover time and takeover quality of each individual driver. Essentially, the prediction can be formulated via the following steps: establish driver u along with his/her chronological sequence of takeover time T^{u}=(T₁^{u}, T₂^{u}, . . . T_{|T}_{^{u}}_{|}^{u}) where Tᵢ^{u}∈ [symbol] ∀i ∈[1, |T^{u}|]; obtain the driver's tactile inputs as a context sequence (i.e., using the above mentioned nine variables) [symbol] =( [symbol] , [symbol] , . . . [symbol] ) where [symbol] ∈ [symbol] ∀i∈[1, |T^{u}|]; and predict the next takeover action for the driver, i.e. T_{|T}_{^{u}}_{|+1}^{u}∈ [symbol] . [symbol] represents a set of real numbers. ∀ represents the universal quantifier, meaning “for all”. Both are mathematical symbols instead of variables.

Given the takeover sequence T^{u} and the context sequence [symbol] , both are [symbol] first transformed to have a fixed length n, which are tuned as a hyperparameter. Hyperparameters are parameters whose values control the learning process and determine the values of model parameters that a learning algorithm ends up learning. If |T^{u}|>n, the most recent n actions are kept, otherwise both T^{u}, [symbol] are padded with the [symbol] required number of padding elements (from the left, meaning the padding elements will be in the same format of T^{u}, [symbol] , but the values of them are synthetic based on historical [symbol] data). Given the padded gap and context sequences, we then concatenate them followed by an affine Multi-Layer Perceptron (MLP) transformation to obtain an intermediate representation such as the following:

$$= ( {W}_{e}^{T} \cdot ( {T}_{i}^{u} ‖ ) + {b}_{e} \vert ∀ i ∈ [ 1 , \vert {T}^{u} \vert ] ) , \qquad ( 1 )$$

where Wₑ∈ [symbol] and bₑ∈ [symbol] represent the parameters of the embedding transformation, and ‘∥’represents the concatenation operation. Consequently, a learnable position embedding is injected, which is meant to inherently learn the dynamics of different positions through an embedding matrix Pₑ∈ [symbol] to get the final input embedding [symbol] = [symbol] +Pₑ^{T}.

Given the embedded input sequence [symbol] , a Gated Recurrent Unit (GRU) is employed to embed it in a lower dimensional latent space. More formally, the GRU maintains a hidden-state vector hₜ∈ [symbol] for each time-step in the sequence and updates it as set forth here:

$${h}_{t + 1} = GRU ( {h}_{t} , ) ,$$

where GRU represents the standard set of update-gate and reset-gate equations. A fixed-size representation of the entire sequence is finally obtained by extracting only the last hidden-state as processed by the GRU i.e. ε_{GRU}: h_{|T}_{^{u}}_{|}.

The same embedded input sequence [symbol] is re-used as input for the Transformer component as well. Multi-head attention on [symbol] is first performed by splitting the input into multiple segments at each timestep and applying attention to each of them individually. After computing the attention function on each segment, the resulting vectors are concatenated again to get the final attentive intermediate representation [symbol] for each time-step. More formally, given h heads:

$$= [ {head}_{0} ‖ {head}_{1} ‖ ... ‖ {head}_{h} ] \qquad ( 2 )$$

$$= [ {𝒮}_{t , 0}^{u} ‖ {𝒮}_{t , 1}^{u} ‖ ... ‖ {𝒮}_{t , h}^{u} ]$$

$${head}_{i} = Attention ( {𝒮}_{t , i}^{u} , {𝒮}_{t , i}^{u} , {𝒮}_{t , i}^{u} ) ,$$

$$Attention ( Q , K , V ) = Soft max ( \frac{Q \cdot {K}^{T}}{\sqrt{d / h}} ) \cdot V , \qquad ( 3 )$$

Note that further affine transformations are not used on the attention inputs [symbol] in Equation (2) before sending it to the Attention layer, large amounts of model are otherwise noted as overfitting in our experiments. It is also pointed out that the attention matrix is explicitly masked in Equation (3) with a lower triangular matrix to not include connections for future time-steps and maintain causality. Note however, that the overall process in Equation (3) is still linear. To this end, Transformer adds a series of non-linear, residual, feed-forward network layers to increase model capacity, as follows:

$$= + , \qquad ( 4 )$$

$$= {Conv}_{2} ( Re LU ( {Conv}_{1} ( ) ) ) ,$$

where Conv₁ and Conv₂ are parametrized by different bilinear parameters W₁, W₂ ∈ [symbol] . A fixed-size representation of the entire sequence is finally obtained by extracting only the last hidden-state as processed by the Transformer i.e. ε_{Transformer}:= [symbol] _{|T}_{^{u}}_{|}.

### Online Inference Phase 430

Once the different clusters are obtained by HCA and the important variables/features are identified by PCA (via Algorithm 2 above), drivers can be classified into those clusters based on their tactile behaviors during the time horizon of t_{classify}. By proposing the k-NN algorithm (as stated in Algorithm 3 below), the driver is classified into the same type as those that share the similar driving behavior.

Algorithm 3 k-NN: Classify the new driver

```
    Input: 1) The tactile inputs of the driver during the
time horizon t_{classify}. 2) Sample data of clustered
drivers. 3) The number of neighbors to be considered.
    Output: The type of the user.
1: Compute the data matrix X which contains the
nine variables;
2: Compute the similarity between the driver and all
other previous drivers, where Sᵢ= ∥X − Xᵢ∥₂²;
3: Rank S and pick out the top k samples;
4: Do majority-voting
  For k samples
  | If (sample = type1): {type1.VOTE +1}
  | Else: {type2.VOTE +1}
  End
  If (type1.VOTE >= type2.VOTE): {Type = Type 1}
    Else: Type = Type 2.
```

### Online Calculation Phase

The online calculation phase is effectively working as the output of the system, whenever the L3 automated driving systems identifies a complex scenario (i.e., while the vehicle is being autonomously controlled by the AV control system) that requires the driver to take over soon, the pre-trained Transformer model will be applied to the current driver of this vehicle, and then predict his/her takeover action to be performed. Once these are calculated in real-time, the automated driving system will adjust its takeover warning alert accordingly.

For example, based on the upcoming traffic scenario where a construction zone is in place 300 meters down the road, the pre-trained Transformer model takes in the past X time-steps of tactile inputs of the driver and predicts he/she will have a duration of 3 seconds to take over the control, then the system will send out a warning alert/message to the driver 5 seconds in advance (i.e., providing a 2-second safety buffer) to guarantee safety. Of course, this buffer may differ in amount as desired, or may differ depending on the particular situation that occurs while driving.

Ideally, the aforementioned process occurs as a rolling time-window prediction with a window size of X=5 for example, where the takeover time is a one dimension time-series data and the tactile inputs correspond to the nine variables of driver behavior discussed above. More specifically, the process can be realized by the following procedures:

1. Linear Self-Attention 426 with a Sliding Time-Window Input:

An important aspect of this disclosure is that the online prediction (per the online prediction phase 420) of the driver's takeover time is made based on a time-series of his/her past tactile inputs instead of an instantaneous input. Compared to an instantaneous input from a single time-step, a time series can take into account the change of the driver's status over a recent period and better capture the change of his/her readiness to take over control from the vehicle from the autonomous vehicle control system. Of course, instantaneous input from a single time-step may alternatively be employed, even though it is considered a less ideal scenario.

Since the example Transformer is inherently quadratic and requires [symbol] (n²) memory as demonstrated by Equation (3) above where there is a Softmax call (which assigns probabilities in classification tasks) over an n×n attention matrix, a relatively short window of previous token connections is adopted for generalization in the Transformer architecture. The [symbol] notation described here is a mathematical expression [symbol] that describes the efficiency of algorithms when their arguments tend to be a very large number. It is used to describe both the time and space complexity of a given function. A sliding-window-based attention restriction mechanism is followed that only attends to an input sequence of X previous elements (e.g., x=3) for every element in the sequence. This provides the benefits of better downstream generalization and performance, as well as linear memory requirements during training and inference allowing the scaling to long driving trajectories.

### 2. Transformer Prediction:

To obtain the final context representation, the importance of the GRU and Transformer architectures' embeddings are dynamically inferred by learning two scalar parameters α, β∈ [symbol] and performing a weighted average, as follows:

$$ε = ( {α}^{′} \cdot {ε}_{GRU} ) + ( {β}^{′} \cdot {ε}_{Transformer} ) , \qquad ( 5 )$$

$$[ {α}^{′} , {β}^{′} ] = Soft max ( [ α , β ] ) ,$$

Having represented [symbol] in a small latent-space by ε∈ [symbol] , a series of non-linear affine transformations is performed to predict the takeover time at the next time-step, as follows:

$${\hat{T}}_{\vert {T}^{u} \vert + 1}^{u} = {T}_{\vert {T}^{u} \vert}^{u} + Δ u , \qquad ( 6 )$$

$$Δ u = ( {F}_{2}^{T} \cdot Re LU ( {F}_{1}^{T} \cdot ε + {b}_{1} ) ) + {b}_{2} , \qquad ( 7 )$$

where F₁∈ [symbol] , F₂∈ [symbol] , and b₁, b₂∈ [symbol] represent the parameters for decoding E to predict the takeover time. It should be pointed out that the change in takeover time is predicted from the previous time-step rather than the exact takeover time itself (Equation (7)), as doing so eliminates redundant learning and directly focuses on the prediction task.

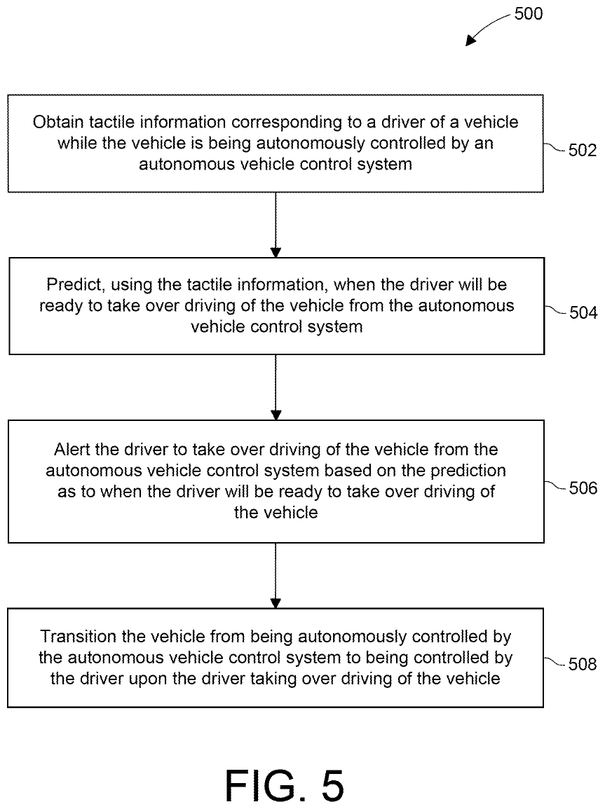

FIG. 5 is a flowchart illustrating example operations that can be performed for transitioning a vehicle from being autonomously controlled by an autonomous vehicle control system to being controlled by a driver, in accordance with some embodiments disclosed herein. Inherent in this process is the ability to provide driver takeover prediction with tactile inputs when transitioning the vehicle from being autonomously controlled by the autonomous vehicle control system to being controlled by the driver. Example method 500 may be performed by the corresponding systems of the vehicles illustrated in FIGS. 1-2.

At operation 502, tactile information is obtained corresponding to a driver of a vehicle while the vehicle is being autonomously controlled by an AV control system. As mentioned above, the tactile information is determined based on tactile inputs obtained by various tactile interfaces embedded within or on, for example, the steering wheel 221, seat 222 (including top seat portion 222a and bottom seat portion 222b), seat belt 223, pedal 224, dashboard 225, and/or clothing 226.

At operation 504, a prediction is made, using the tactile information, as to when the driver will be ready to take over driving of the vehicle from the AV control system. The tactile information may be derived from offline and/or online sources, and may use driver type classification.

At operation 506, the driver is alerted to take over driving of the vehicle from the AV control system based on the prediction as to when the driver will be ready to take over driving of the vehicle. The alert may be in the form of an audio signal such as an automated voice or a beep or other tone that the driver will hear. Alternatively, the alert may be in the form of a visual textual message or other visual non-textual indicator such as an icon or symbol. The textual message or other visual non-textual indicator may be visually provided to the driver via the dashboard or other display such as a heads-up display. As another alternative, the alert may be provide to the driver in other ways such as via tactile feedback using a tactile interface embedded within or on, for example, the steering wheel 221, seat 222 (including top seat portion 222a and bottom seat portion 222b), seat belt 223, pedal 224, dashboard 225, and/or clothing 226.

At operation 508, the vehicle is transitioned from being autonomously controlled by the AV control system to being controlled by the driver upon the driver taking over driving of the vehicle. The alert is provided to the driver at a predicted takeover time that is sufficiently prior to the transition of the vehicle from being autonomously controlled by the AV control system to being controlled by the driver, and therefore the transition is achieved in a smooth and safe manner.

In some examples, the tactile information is used to classify the driver into a driver type, wherein the prediction made in operation 504 above is based on the driver type. In one example, the driver is identified based on the driver type. In another example, the driver type comprises a driving behavior of the driver. The driving behavior of the driver may identify the driver as a distracted driver or an engaged driver. In a further example, the alerting made in operation 506 above is adjusted time-wise based on whether the driver is identified as a distracted driver or an engaged driver.

In some examples, the tactile information is used to classify the driver into one driver type selected from a plurality of driver types which are stored remotely and which correspond to multiple drivers, wherein the prediction made in operation 504 above is based on the one driver type.

In some examples, the tactile information is obtained using at least one tactile interface selected from the group consisting of a steering wheel, seat, seat belt, pedal, dashboard, and clothing. In one example, the tactile information is obtained using a steering wheel tactile interface, wherein the tactile information is based on hand orientation of the driver on the steering wheel. In another example, the tactile information is obtained using a seat tactile interface, wherein the tactile information is based on seating position of the driver on the seat.

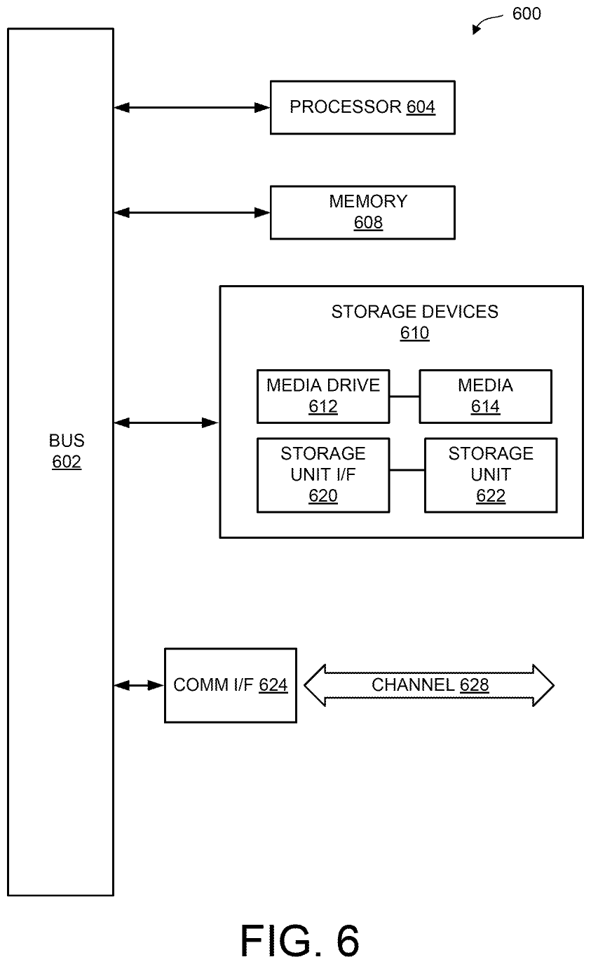

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices, such as a processor 604. Processor 604 might be implemented using a general-purpose or special purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanisms/devices 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanisms/devices 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 622, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

Although embodiments are described above with reference to a Level 3 autonomous vehicle, the autonomous vehicle described in any of the above embodiments may alternatively be a non-Level 3-type autonomous vehicle. Such alternatives are considered to be within the spirit and scope of the present invention, and may therefore utilize the advantages of the configurations and embodiments described above.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining tactile information corresponding to a driver of a vehicle while the vehicle is being autonomously controlled by an autonomous vehicle control system;
predicting, using the tactile information, when the driver will be ready to take over driving of the vehicle from the autonomous vehicle control system;
alerting the driver to take over driving of the vehicle from the autonomous vehicle control system based on the prediction as to when the driver will be ready to take over driving of the vehicle; and
transitioning the vehicle from being autonomously controlled by the autonomous vehicle control system to being controlled by the driver upon the driver taking over driving of the vehicle.

2. The method of claim 1, wherein the method further comprises using the tactile information to classify the driver into a driver type, and wherein the predicting step is based on the driver type.

3. The method of claim 2, wherein the driver type comprises a driving behavior of the driver.

4. The method of claim 3, wherein the driving behavior of the driver identifies the driver as a distracted driver or an engaged driver.

5. The method of claim 4, wherein the method further comprises adjusting, time-wise, the step of alerting based on whether the driver is identified as a distracted driver or an engaged driver.

6. The method of claim 2, wherein the method further comprises identifying the driver based on the driver type.

7. The method of claim 1, wherein the method further comprises using the tactile information to classify the driver into one driver type selected from a plurality of driver types which are stored remotely and which correspond to multiple drivers, and wherein the predicting step is based on the one driver type.

8. The method of claim 1, wherein the tactile information is obtained using at least one tactile interface selected from the group consisting of a steering wheel, seat, seat belt, pedal, dashboard, and clothing.

9. The method of claim 1, wherein the tactile information is obtained using a steering wheel tactile interface, and wherein the tactile information is based on hand orientation of the driver on the steering wheel.

10. The method of claim 1, wherein the tactile information is obtained using a seat tactile interface, and wherein the tactile information is based on seating position of the driver on the seat.

11. A vehicle comprising:
a processor; and
a memory coupled to the processor to store instructions, which when executed by the processor, cause the processor to perform operations, the operations comprising:
obtaining tactile information corresponding to a driver of the vehicle while the vehicle is being autonomously controlled by an autonomous vehicle control system;
predicting, using the tactile information, when the driver will be ready to take over driving of the vehicle from the autonomous vehicle control system;
alerting the driver to take over driving of the vehicle from the autonomous vehicle control system based on the prediction as to when the driver will be ready to take over driving of the vehicle; and
transitioning the vehicle from being autonomously controlled by the autonomous vehicle control system to being controlled by the driver upon the driver taking over driving of the vehicle.

12. The vehicle of claim 11, wherein the operations further comprise using the tactile information to classify the driver into a driver type, and wherein the predicting step is based on the driver type.

13. The vehicle of claim 12, wherein the driver type comprises a driving behavior of the driver.

14. The vehicle of claim 13, wherein the driving behavior of the driver identifies the driver as a distracted driver or an engaged driver.

15. The vehicle of claim 14, wherein the operations further comprise adjusting, time-wise, the step of alerting based on whether the driver is identified as a distracted driver or an engaged driver.

16. The vehicle of claim 12, wherein the operations further comprise identifying the driver based on the driver type.

17. The vehicle of claim 11, wherein the operations further comprise using the tactile information to classify the driver into one driver type selected from a plurality of driver types which are stored remotely and which correspond to multiple drivers, and wherein the predicting step is based on the one driver type.

18. The vehicle of claim 11, wherein the tactile information is obtained using at least one tactile interface selected from the group consisting of a steering wheel, seat, seat belt, pedal, dashboard, and clothing.

19. The vehicle of claim 11, wherein the tactile information is obtained using a steering wheel tactile interface, and wherein the tactile information is based on hand orientation of the driver on the steering wheel.

20. The vehicle of claim 11, wherein the tactile information is obtained using a seat tactile interface, and wherein the tactile information is based on seating position of the driver on the seat.

21. A non-transitory machine-readable medium having instructions stored therein, which when executed by a processor, cause the processor to perform operations, the operations comprising:
obtaining tactile information corresponding to a driver of a vehicle while the vehicle is being autonomously controlled by an autonomous vehicle control system;
predicting, using the tactile information, when the driver will be ready to take over driving of the vehicle from the autonomous vehicle control system;
alerting the driver to take over driving of the vehicle from the autonomous vehicle control system based on the prediction as to when the driver will be ready to take over driving of the vehicle; and
transitioning the vehicle from being autonomously controlled by the autonomous vehicle control system to being controlled by the driver upon the driver taking over driving of the vehicle.
